(19) United States
(12) Patent Application Publication
(10) Pub. No.: US 2008/0190847 A1
(43) Pub. Date: Aug. 14, 2008

(54) Apparatus and Method

(75) Inventor: Alan David Cole Cantwell, Aston (GB)

Correspondence Address: Arnold S Weintraub;The Weintraub Group, 32000 Northwestern Highway, Suite 240, Farmington, MI, 48334, US

(73) Assignee: BRIGHTWATER ENGINEERING LIMITED, Hertfordshire (GB)

(21) Appl. No.: 11/662,378

(22) PCT Filed: Sep. 2, 2005
(86) PCT No.: PCT/GB2005/003418

§ 371 Date: Jan. 11, 2008

(30) Foreign Application Priority Data
Sep. 10, 2004 (GB) 0420071.3

(51) Int. Cl. C02F 3/12; B01D 61/18; B01D 63/08; B01D 65/08; C02F 1/44

(52) U.S. Cl. 210/652; 210/321.65; 210/150

(57) ABSTRACT

An activated sludge system for the purification of wastewater includes a membrane reactor comprising: (i) an array of pairs of vertical membranes (14) parallel to each other, (5) the membranes being spaced apart from each other and being permeate to liquid but substantially impermeable to solid particles, (ii) liquid flow channels between the membranes (14) of each pair, (iii) a liquid-collecting channels communicating with the liquid-flow channels for receiving liquid which has permeated through the membranes (14), and (iv) gaseous fluid sparging ducts (5) allocated to and co-planar with the respective pairs of membranes (14) and extending substantially horizontally for introducing gaseous fluid into a mixture of the liquid and the solid particles about the array, so that the gaseous fluid rises through the gaps (8) among the outer major surfaces of the membranes (14), each of the ducts 5 having therealong only one row of sparge holes (6), those holes (6) being downwardty directed for emitting the gaseous fluid downwardty.

The present invention relates to apparatus and a method for separating liquid from a mixture of solid particles and liquid.

Within an activated sludge system for the purification of wastewater such as grey water, sewage or industrial effluent, it is known to use water-permeable, planar membranes to effect solids separation.

In such known system, a pair of membranes are attached to respective opposite sides of each plate of a row of rectangular supporting plates positioned in parallel vertical planes by means of a structure, referred to as a cassette, submerged in a tank containing the activated sludge in high concentration. This activated sludge consists of suspended solids flocs within which reside the active bacteria, which remove dissolved and solid nutrients contained within the wastewater fed into the tank. The bacteria require dissolved oxygen in order to achieve this purpose and this is derived from a flow of air led to and distributed at the base of the cassette located on the tank floor. The air also lifts the liquid and solids among the membrane/plate assemblies so that cross-flow filtration is achieved wherein pure liquid is able to pass through the membrane owing to a differential pressure across the membrane, without the membrane surface being blocked by the filtered solids. Blocking is encouraged by deposition onto the membrane of polysaccharides generated by the bacteria in the sludge. The membrane is in effect cleaned by the flow of liquid induced by the stream of air rising among the assemblies.

The volumetric rate and uniformity of application of air applied to the gap between facing membranes of each two adjacent assemblies to produce the circulation of sludge is a critical factor in determining the cost and effectiveness of the overall process. If too high a flowrate of air is applied, then membranes can be damaged by the shear induced by the liquid flow. If too low a rate of air is applied, then blockage of the outer surfaces of the membranes by accumulation of filtered solids occurs. A further problem created by excessive airflow is that bubbles of air coalesce and this reduces the efficiency of transfer of dissolved oxygen into the liquid phase. If air is not supplied uniformly across the outer surface of each membrane then dead spots can develop which reduce system capacity. The position, number and detail of air sparging pipes, together with the air flowrate, determine the extent of this problem.

For each assembly, the permeability to pure liquid of the membrane itself and the resistance to flow produced by the pure liquid flow paths on the membrane-supporting plate determine the capacity to perform treatment. In the short term a high permeability membrane is desirable but in the long term this may lead to blockage of the membrane pores if small sized suspended solids and bacteria are able to pass through the outer surface of the membrane into the body of the membrane. Also, if care is not taken with the arrangement for routing and collecting the purified liquid after leaving the membrane itself and then through and out of the assembly, throughput will be limited to less than the permeability of the membrane alone would allow.

The Abstract of JP-A-07-132214 seems to disclose a membrane/plate assembly in which a filter membrane is provided covering a surface of a membrane supporting plate, with a permeated liquid passage communicating with a permeated liquid suction pipe being formed on the plate, the permeated liquid passage being composed of a liquid collecting part communicating with the suction pipe and a slit. It appears that each major vertical surface of the plate is formed with a network of horizontal and vertical slots communicating with that liquid collecting part. It seems to be asserted that the assembly can be economically produced and facilitate the flow of a membrane-permeated liquid and be capable of easily filtering a liquid to be treated.

The Abstract of JP-A-09-299951 seems to disclose a liquids/solids separation device including a cassette containing submerged assemblies each comprised of a flexible water-permeable material covered on both surfaces with filter membranes. It appears that the assemblies are arranged in a tank vertically and in parallel at a constant spacing, and permeated liquid take-off parts are provided vertically at both ends, or at one end, of the cassette, and a sparging duct is provided on the bottom of each assembly itself. It seems to be asserted that the separation device enables continuance of efficient filtering for a long period while cakes on the membranes are efficiently removed.

Seemingly, the Abstract of JP-A-10-033955 discloses a membrane separation apparatus equipped with a membrane separation tank, a filter membrane unit consisting of a large number of vertical hollow-yarn flat membrane modules arranged mutually parallelly so as to leave intervals among them and arranged in the tank, and a plurality of air sparging pipes arranged under the filter membrane units in the membrane separation tank. It appears that the pipes are arranged mutually parallelly so as to provide intervals therebetween, and that a plurality of lateral air sparging holes are formed in both sides of the pipe wall of each of the pipes at intervals therealong, the air sparging holes of the adjacent pipes being mutually opposed. It seems to be asserted that this arrangement prevents clogging of the air sparging holes and disperses throughout a liquid air bubbles blown out of the holes.

US-A-2003/0150808 discloses a separation membrane having a porous substrate and a porous resin layer on at least one surface of the porous substrate, the porous resin layer containing a resin. Part of the resin permeates through the porous substrate to form a composite layer. At least one of the following relationships (1) and (2) is satisfied:
1. the porous resin layer has an average pore size in the range of 0.01 to 0.2 μm and a standard variation of the pore size of 0.1 μm or less at the surface, and
2. the porous resin layer has macrovoids having short diameters of 0.05×A or more wherein A represents the thickness of the porous substrate, and the rejection of micro particles having an average particle size of 0.9 μm is at least 90%.
   The membranes are included in membrane/plate assemblies in each of which a pair of the membranes is arranged on channel members on the respective opposite major surfaces of a rigid plate formed with recesses for flow of the permeated liquid toward the exterior.

According to one aspect of the present invention, there is provided apparatus comprising:—
(i) an array of pairs of substantially vertical membranes substantially parallel to each other, each membrane having substantially vertical inner and outer major surfaces at respective opposite sides of the membrane, the membranes being spaced apart from each other and being permeable to liquid but substantially impermeable to solid particles,
(ii) a liquid flow channel arrangement between the membranes of each pair,
(iii) a liquid-collecting arrangement communicating with the liquid-flow channel arrangements for receiving liquid which has permeated through said membranes, and
(iv) gaseous fluid sparging ducts allocated to and substantially co-planar with the respective pairs of membranes and extending substantially horizontally for introducing gaseous fluid into a mixture of said liquid and said solid particles about said array, so that said gaseous fluid rises through the gaps among the outer major surfaces of the membranes, each of said ducts having therealong only one row of sparge holes, those holes being downwardly directed for emitting said gaseous fluid downwardly.

Owing to this aspect of the invention, the gaseous fluid can be reliably uniformly distributed relative to each membrane, so that any solid particles tending to accumulate on the outer surface of the membrane are swept back into the bulk of the mixture, so discouraging the formation of dead spots at that surface.

The sparge holes of each row need not be aligned longitudinally of the relevant duct but should not include a plurality of holes in substantially a radial plane of the duct, since otherwise control of the flows of gaseous fluid from the duct may be compromised.

Advantageously, the sparge holes of the single row pertaining to each duct are located within an included angle, extending from a longitudinal centreline of the duct, of no more than one quarter of a right-angle, preferably no more than 20°, centred at a vertical plane through that centreline. Highly desirably, the sparge holes are almost vertically downwardly directed.

According to a second aspect of the present invention, there is provided apparatus comprising:—
(i) an array of pairs of substantially vertical membranes substantially parallel to each other, each membrane having substantially vertical inner and outer major surfaces at respective opposite sides of the membrane, the membranes being spaced apart from each other and being permeable to liquid but substantially impermeable to solid particles,
(ii) a liquid flow channel arrangement between the membranes of each pair,
(iii) a liquid-collecting arrangement communicating with the liquid-flow channel arrangements for receiving liquid which has permeated through said membranes, and
(iv) gaseous fluid sparging ducts substantially parallel to the membranes and extending substantially horizontally for introducing gaseous fluid into a mixture of said liquid and said solid particles about said array, so that said gaseous fluid rises through the gaps among the outer major surfaces of the membranes, each gaseous fluid sparging duct being formed with sparge holes distributed therealong, the entrance mouths of those holes in a middle portion of each duct being of greater width than those of those holes in an end portion of the duct.

According to a third aspect of the present invention, there is provided apparatus comprising:—
(i) an array of pairs of substantially vertical membranes substantially parallel to each other, each membrane having substantially vertical inner and outer major surfaces at respective opposite sides of the membrane, the membranes being spaced apart from each other and being permeable to liquid but substantially impermeable to solid particles,
(ii) a liquid flow channel arrangement between the membranes of each pair,
(iii) a liquid-collecting arrangement communicating with the liquid-flow channel arrangements for receiving liquid which has permeated through said membranes, and
(iv) gaseous fluid sparging ducts substantially parallel to the membranes and extending substantially horizontally for introducing gaseous fluid into a mixture of said liquid and said solid particles about said array, so that said gaseous fluid rises through the gaps among the outer major surfaces of the membranes, each gaseous fluid sparging duct being formed with sparge holes distributed therealong at intervals of no more than 30 mm.

Owing to these aspects of the invention, the gaseous fluid can be uniformly distributed widthwise of each membrane and so reliably avoid the formation of dead spots. We have ascertained surprisingly that the intervals among the sparge holes should be no more than 30 mm. to achieve this desirable aim.

Advantageously, each membrane is an ultrafiltration membrane with pore size of between 0.01 microns and 0.05 microns, preferably between 0.03 microns and 0.05 microns. A particularly suitable membrane comprises an outer layer of polyether sulphone upon a fibrous thermoplastics substrate.

Preferably, between the membranes of each pair of membranes there is a plate having respective opposite major surfaces substantially parallel to each other, the membranes of each pair of membranes extending over and being spaced outwardly from the respective major surfaces of the relevant plate, first and second sets of substantially vertical, liquid-flow, linear grooves being formed in the respective major surfaces of each plate, the grooves in each set being parallel to each other. Each two adjacent grooves in each set are spaced apart from each other by between 10 mm. and 50 mm., in particular between 20 mm. and 30 mm., and each groove is of a width of between 0.5 mm. and 2 mm., in particular between 1 mm. and 1.5 mm.

Again preferably, first and second sets of liquid-collection grooves are formed in the respective major surfaces of each plate and extend transversely of and intersect the respective first and second sets of liquid-flow linear grooves. Each of the liquid-collection grooves is of a width of between 0.5 mm. and 2 mm., in particular between 1 mm. and 1.5 mm. Each of the liquid-collection grooves is of a depth of between 2 mm. and 5 mm. Moreover, each two adjacent liquid-collection grooves in each set are spaced apart from each other by between 1 mm. and 5 mm., in particular between 2 mm. and 3 mm.

In one preferred embodiment, the ducts are pipes perforated to provide, distributed along each pipe, the sparge holes for the gaseous fluid. In another preferred embodiment, the ducts are formed through lower parts of the respective plates and communicate with the sparge holes distributed therealong for the gaseous fluid. In each of those embodiments, the sparge holes are directed obliquely downwardly and each sparge hole is of a substantially frusto-conical form widening outwardly. Each sparge hole has an entrance mouth diameter of 1.5 mm. to 2.5 mm.

The apparatus may further comprise two manifolds connected to the respective ends of the ducts for supplying the gaseous fluid to the ducts in respective opposite longitudinal directions of the ducts, in which case those of the holes at middle portions of the respective ducts have larger entrance mouth diameters than those of the holes at portions of the respective ducts nearer to the ends of the ducts.

The apparatus may be included in an activated sludge system, the mixture being activated sludge and the gaseous fluid comprising oxygen.

According to a fourth aspect of the present invention, there is provided an assembly for use in separating liquid from a mixture of solid particles and liquid, and comprising:—

a pair of substantially planar membranes which are substantially parallel to each other and are permeable to said liquid but substantially impermeable to said solid particles, each membrane being an ultrafiltration membrane with pore size of between 0.01 microns and 0.05 microns.

Owing to this aspect of the invention, even very small solid particles are prevented from entering the membrane and thus gradually blocking it, whilst the liquid can flow relatively easily through the membrane.

According to a fifth aspect of the present invention, there is provided an assembly for use in separating liquid from a mixture of solid particles and liquid, and comprising:—
(i) a plate having respective opposite major surfaces substantially parallel to each other,
(ii) first and second membranes extending over and spaced outwardly from the respective major surfaces of said plate and permeable to said liquid but substantially impermeable to said solid particles, and
(iii) first and second sets of liquid-flow linear grooves formed in said respective major surfaces, the grooves in each set being parallel to each other, each two adjacent grooves in each set being spaced apart from each other by between 10 mm. and 50 mm., and each groove being of a width of between 0.5 mm. and 2 mm.

Owing to this aspect of the invention, the grooves provide easy routes for liquid to leave the plate and yet the membranes (or spacer mesh provided between the plate, on the one hand, and the membranes, on the other hand) are deterred from entering the grooves and so restricting them.

According to a sixth aspect of the present invention, there is provided an apparatus for use in separating liquid from a mixture of solid particles and liquid, and comprising:—
(i) a plate having respective opposite major surfaces substantially parallel to each other,
(ii) first and second membranes extending over and spaced outwardly from the respective major surfaces of said plate and permeable to said liquid but substantially impermeable to said solid particles,
(iii) first and second sets of liquid-flow linear grooves formed in said respective major surfaces, the grooves in each set being parallel to each other, and
(iv) first and second sets of liquid-collection grooves formed in said respective major surfaces and extending transversely of and intersecting the respective first and second sets of liquid-flow linear grooves, each of the liquid-collection grooves being of a width of between 0.5 mm. and 2 mm.

Owing to this aspect of the invention, the provision of more than one liquid-collection groove intersecting each liquid-flow linear groove and of the given width tends to deter the membranes (or spacer mesh provided between the plate, on the one hand, and the membranes, on the other hand) from entering the liquid-collection grooves and thus restricting them.

According to a seventh aspect of the present invention, there is provided a method of separating liquid from a mixture of solid particles and liquid, comprising introducing gaseous fluid into said mixture so as to form a plurality of substantially vertical curtains of gaseous bubbles, with the curtains being substantially parallel to each other, carrying the mixture upwards among a plurality of membranes which are substantially parallel to said curtains and which are permeable to said liquid and substantially impermeable to said solid particles, some of the liquid from said mixture flowing through said membranes, and collecting that liquid which has flowed through said membranes and thus been separated from said solid particles, said introducing comprises directing said gaseous fluid downwardly into said mixture within an included angle, centred on a vertical plane, of no more than one half of a right-angle.

The supply of the correct volume of air uniformly across the base of each membrane is needed for correct operation. To this end the gap between each two adjacent membrane/plate assemblies can be supplied with air from an individual duct in the form of an aeration pipe with downwardly facing sparging holes along the pipe. Each pipe is set 25 mm. to 50 mm. below the corresponding assembly and in the same plane as and parallel to the assembly. The sparge holes are set at an inclination to the vertical plane so that air passes readily to one side of the pipe and then passes up through the gap between the two assemblies. The pipe is fed with air from a common manifold at each end of the pipe. The size of the holes is varied along the length of the pipe, growing larger towards the centre, so as to give equal flow from each hole. This is to try to ensure that the cleaning action is laterally and vertically uniform.

Alternatively, a horizontal duct can be provided by fabrication in the lower 5 cm of the support plate. Air is then distributed into the liquid by downwardly inclined sparge holes across the base of the support plate, as for the external sparge pipe described above. Air is fed to this integral sparge duct by vertical bores extending from the top to the bottom of the support plate and fed by an air manifold at the top of the plate.

The membrane used is advantageously of an ultra-filtration character with a pore size of 0.01 microns to 0.05 microns. Thus bacteria and other small solid particles are excluded from the membrane body. This confers long membrane life and low frequency of chemical cleaning to reverse fouling of the membrane thus maintaining permeability. Cleaning frequency is typically reduced to less than once per six to twelve months or longer. A preferred membrane is of polyether sulphone deposited on a substrate of polypropylene or polyester fibrous material. Such membrane can be attached around its perimeter to the rectangular backing plate by thermal welding, ultrasonic welding, or an adhesive. A spacer of a fine mesh is placed between the membrane and the backing plate. The backing plate also has, in each major surface, a plurality of vertical grooves, these being 1 mm. to 1.5 mm. in depth and width, extending from top to bottom of the backing plate. These dimensions are chosen so that the spacer mesh and the membrane are not sucked into the grooves, which would reduce the liquid-carrying capacity of the grooves. The frequency of these grooves is such that the resistance to flow through the membrane and the spacer mesh is low and is not the limiting resistance to flow. At the top of each plate a set of horizontal, liquid-collecting grooves are formed in each major surface. The number of these is 5 to 10 and each is 1 mm. to 1.5 mm. wide by 1 mm. to 3 mm. deep, so that again the spacer mesh and the membrane are not drawn into the groove, yet adequate liquid-carrying capacity at minimal pressure drop is provided. One or two liquid exit pipes of 5 mm. or 6 mm. internal diameter are set into the top of the support plate, intersecting the horizontal collection grooves and giving a final exit route for liquid filtrate from the membrane into a collection manifold. This external manifold is kept at a lower hydraulic pressure than the treatment tank by connection to either a pump or a siphon.

Each membrane is held tightly to its support plate by, preferably, thermal or ultrasonic sealing seams so as to avoid ‘rucking up’ by the shear induced by the upflowing liquid and air. The spacer mesh is also kept in position by these seams.

The use of a spacer mesh can be avoided if the whole of the adjacent major surface of the backing plate is formed with connecting ‘hill and valley’ pattern with cross-sectional dimensions less than 0.5 mm.

The backing plates are set into a containing cassette by sliding into the slots in slotted guide plates of the cassette, which enable the two vertical edges of each plate to be positioned such that the membrane/plate assemblies are separated by uniform gaps of 6 mm. to 12 mm. This maintains a free passage for the air and liquid flow whilst retaining sufficient shear to keep the outer surfaces of the membranes clean.

The slotted guide plates are kept rigid by a structure of steel tubing giving sufficient strength both during normal operation and when the cassette is being lifted into or out of the treatment tank. Plate-separating bars are provided along the centre of the array of plates at the top and the bottom so as to maintain plate separation at the centre.

The cassette is designed so that sparging pipes, or the bottom edges of the plates when the sparging ducts are incorporated into the plates, are close to the bottom of the treatment tank, advantageously spaced between 50 mm. and 100 mm. from the bottom of the tank. This makes the transfer of oxygen more efficient owing to higher hydraulic pressure and maximises the distance traveled by air bubbles to the top mixed liquor level.

According to an eighth aspect of the present invention, there is provided a module comprising:—
(i) an array of gaseous fluid sparging ducts substantially parallel to each other for introducing gaseous fluid into a mixture of liquid and solid particles, and
(ii) a manifold at an end of said array for supplying said gaseous fluid to said ducts,

said ducts and said manifold being fixed relative to each other and said module being displaceable as a unit.

Owing to this aspect of the invention, it is possible to facilitate fabrication and installation of the ducts and the manifold and subsequent cleaning and maintenance thereof.

In order that the invention may be clearly and completely disclosed, reference will now be made, by way of example, to the accompanying drawings, in which:—

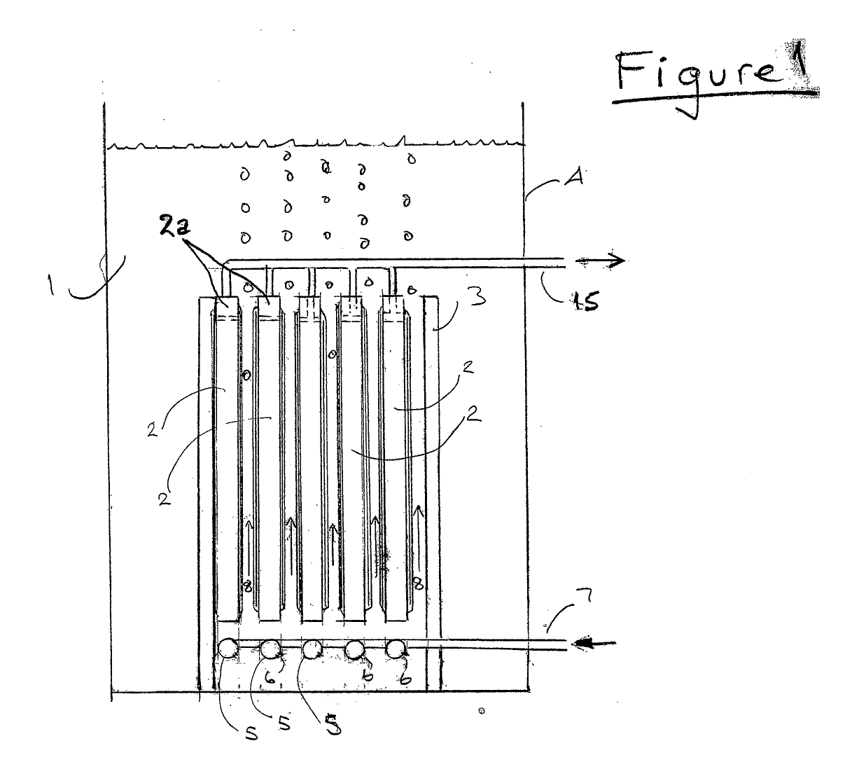

FIG. 1 shows diagrammatically and in side view an activated sludge system;

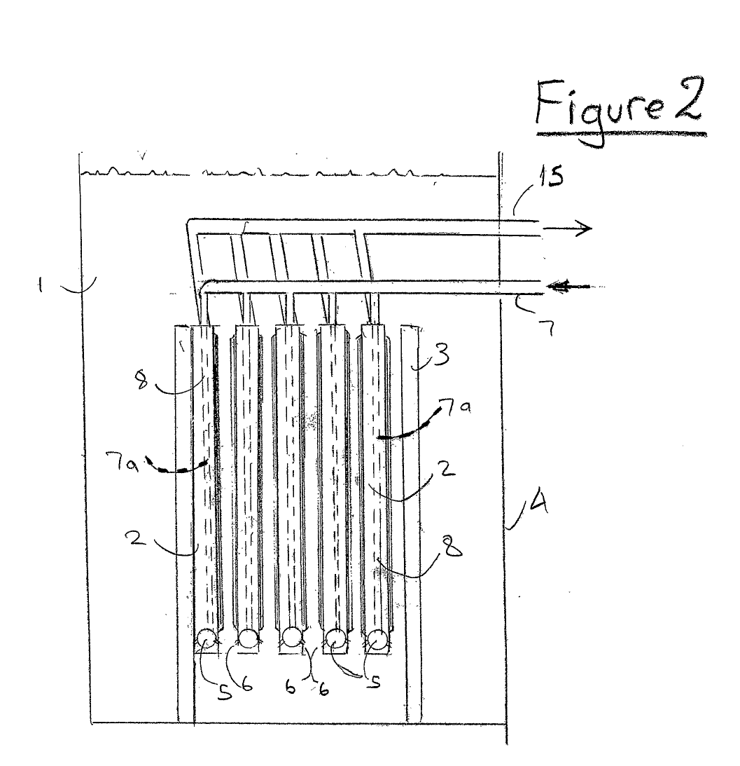

FIG. 2 is a view similar to FIG. 1 of a modified version of the system;

FIG. 3 is a diagrammatic front elevation of one of a plurality of identical membrane/plate assemblies of the system of FIG. 1 or FIG. 2;

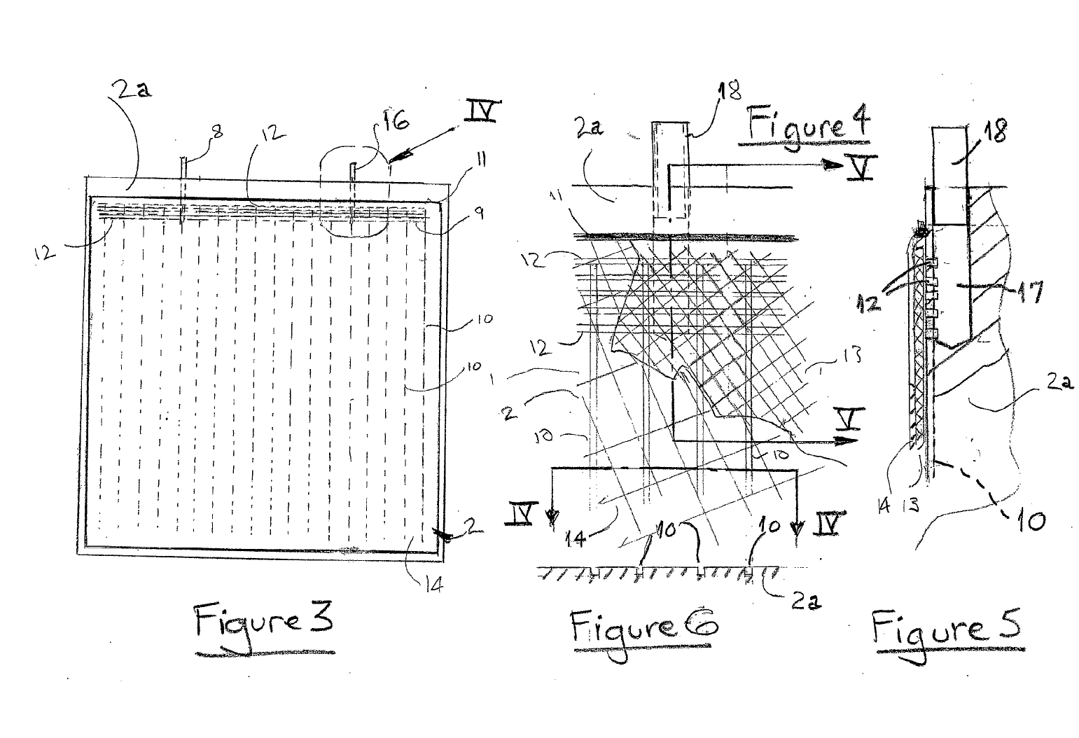

FIG. 4 is a cutaway detail of the portion IV in FIG. 3;

FIG. 5 shows a section taken on the line V-V in FIG. 4;

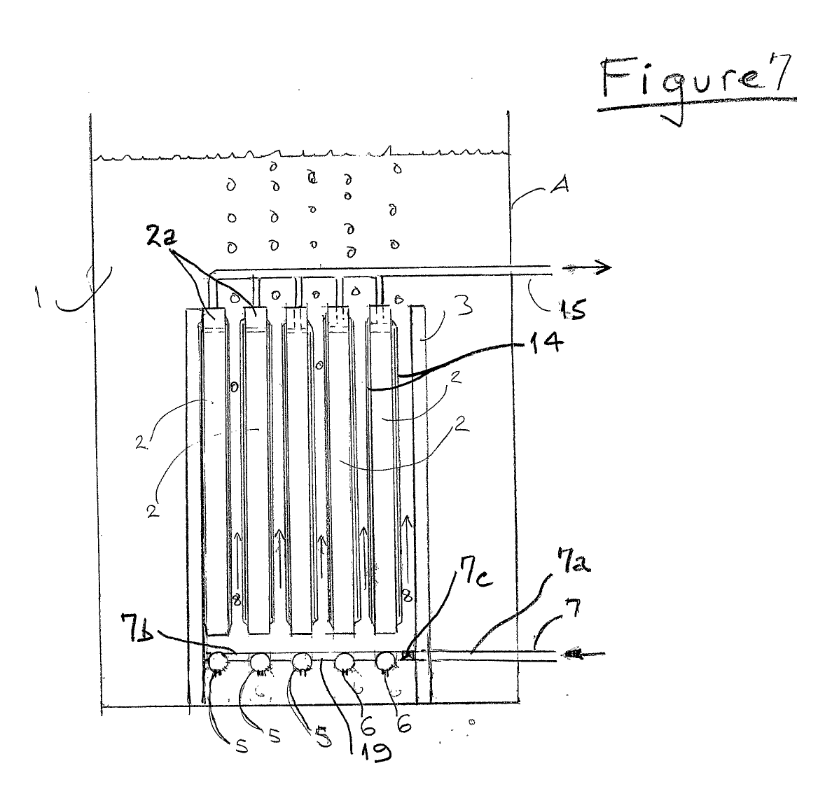

FIG. 6 shows a section taken on the line VI-VI in FIG. 4, and

FIG. 7 is a view similar to FIG. 1 of another modified version of the system.

Referring to FIG. 1, this shows a first version wherein a plurality of membrane/plate assemblies 2 are located within the body of a cassette 3 which is submerged into activated sludge 1 contained within a tank 4. Each membrane/plate assembly 2 is equipped with an individual separate sparge pipe 5 with a multiplicity of sparge holes 6 of 1.5 mm. to 2.5 mm. diameter set to one side and at angle of between 20° and 45° to the vertical plane through the centreline of the sparge pipe 5. The diameter of the entrance mouth of each outlet hole is between 1.5 mm. and 2.5 mm. The holes are also countersunk with an included angle of 120° so as to be of frusto-conical form widening outwardly, which promotes unblocking, by the compressed air supplied to the pipes 5, of blockages by suspended solids should these backflow into the pipes. The size of hole may vary from the end to the centre of the pipe to give uniform airflow from each hole. Air enters two air header manifolds 7, passes through the sparge pipes 5 and sparge holes 6 and then passes up through the gaps 8 among the assemblies 2. The hole spacing is regular and no more than 30 mm. (preferably between 10 mm. and 30 mm., particularly between 15 mm. and 30 mm.), so as to produce an even bubble flow over the whole area of the outer surface of the membrane, in other words a uniformly turbulent mixing action in each gap 8, so as to avoid the formation of dead spots.

In the version shown in FIG. 2, the sparge duct 5 is formed, by casting, moulding, or drilling, in the lower part of the membrane support plate 2a. A vertical air supply header duct 7a is similarly formed vertically within the body of the membrane support plate 2a. These integrated supply ducts are coupled to an air supply conduit 7. Air flows through the sparge holes 6, producing the flows of air and consequent airlifts of sludge up the gaps 8.

The sparge ducts 5 are 5 mm. to 12 mm. internal diameter. The conduit 7 is sized to suit the air flow as determined by the size of each membrane/plate assembly 2 and the number of assemblies. The integrated air ducts 7a are typically 5 mm. to 8 mm. diameter but will be present in a number greater than four, e.g. eight, depending also on the size of the plate. The outlet holes are sized and spaced as stated for the version of FIG. 1.

The plate 2a of each assembly 2 is typically 500 mm. to 1000 mm. wide and 1000 mm. deep with a thickness of 8 mm. to 15 mm. The material may be plain polypropylene (PP) or polyethylene terephthalate (PET). The material can be filled with chopped glass fibre or other reinforcing strands to strengthen and improve the stiffness of the plate. The stiffness is particularly important to maintain uniform gaps 8. Up to one hundred assemblies 2 can contained in a single cassette stood on the base of the treatment tank.

FIG. 3 shows details of a membrane 14 in relation to a membrane support plate 2a and a membrane spacer mesh 13. The membrane 14 is attached to the plate 2a by an ultrasonic or thermal weld 11 made possible by the compatibility of the membrane substrate fibre and the support material of plate 2a. Alternatively, an adhesive may be used.

Resistance to the flow of purified liquid after it leaves the membrane is greatly reduced by the use of the spacer 13 of woven mesh of a plastics such as polyester, nylon or polypropylene. However the use of large membranes 14 and backing plates 2a is made feasible from a standpoint of flow capacity, by the use of a multiplicity of vertical grooves 10 as shown in FIG. 3. These grooves are 1 mm. to 1.5 mm. wide by 1 mm. to 1.5 mm. deep. The spacing between each two grooves 10 is 10 mm. to 25 mm. At the top of the plate a horizontal further set of grooves 12 acts as a liquid collection arrangement. The width of these grooves is 1 mm. to 2 mm. and the depth is 1 mm. to 3 mm. Liquid flow is taken from these horizontal grooves 12 by connectors 16 which consist of vertical bores 17 intersecting the grooves 12 and of outlet stubs 18 which connect to a main exit manifold from the tank. These connectors 8 are 2 mm. smaller in external diameter than the support plate thickness, i.e. 6 mm. to 13 mm. external diameter, with internal diameter of 5 mm. to 12 mm.

In a third embodiment (not shown) the use of a spacer mesh between the membranes and the backing plates can be omitted if the surface finish of the plate is in the form of ‘hills and valleys’ where peak-to-floor distance is 0.5 mm. to 1 mm. and mean width is 0.5 mm. to 1 mm.

The version shown in FIG. 7 differs from that shown in FIG. 1 in two respects. Firstly, the sparge holes 6, which are again arranged in a single row aligned longitudinally of their pipe 5, are at the bottom of the periphery of the pipe. This has the advantage that the pipe is self-cleaning, i.e. the solids which may enter the sparge holes during intervals between sparging periods and accumulate in the lower part of the interior of the pipe are immediately ejected through the holes 6 upon recommencement of sparging, instead of gradually forming a deposit in a lower part of the interior of the pipe and thus gradually reducing the through-flow cross-sectional area of the pipe and the available level of sparging for a given air supply pressure, which reduces the degree of control over the volumetric rate of supply of air to the individual gaps 8.

Moreover, the outlet mouths of the holes 6 are located a very short distance from a vertical central plane of their pipe 5 and to one side of that plane, so that the air injected into the liquid rises at only one side of their pipe 5 and thus into only the desired one of the gaps 8. The holes 6 are preferably orientated to extend radially of the pipe 5.

1-81. (canceled)

82. Apparatus comprising:
(i) an array of pairs of substantially vertical membranes substantially parallel to each other, each membrane having substantially vertical inner and outer major surfaces at respective opposite sides of the membrane, the membranes being spaced apart from each other and being permeable to liquid but substantially impermeable to solid particles,
(ii) a liquid flow channel arrangement between the membranes of each pair,
(iii) a liquid-collecting arrangement communicating with the liquid-flow channel arrangements for receiving liquid which has permeated through said membranes, and
(iv) gaseous fluid sparging ducts allocated to and substantially co-planar with the respective pairs of membranes and extending substantially horizontally for introducing gaseous fluid into a mixture of said liquid and said solid particles about said array, so that said gaseous fluid rises through the gaps among the outer major surfaces of the membranes, each of said ducts having therealong only one row of sparge holes, those holes being downwardly directed for emitting said gaseous fluid downwardly.

83. Apparatus according to claim 82, wherein the sparge holes of each row do not include a plurality of sparge holes in substantially a radial plane of the relevant duct.

84. Apparatus according to claim 82, wherein the sparge holes of each row are located within an included angle, extending from a longitudinal centerline of the relevant duct, of no more than 200.

85. Apparatus according to claim 84, wherein the sparge holes of each row are aligned longitudinally of the relevant duct.

86. Apparatus according to claim 82, wherein the sparge holes of each row are distributed therealong at intervals of no more than 30 mm.

87. Apparatus according to claim 86, wherein said intervals are between 10 mm. and 30 mm.

88. Apparatus according to claim 87, wherein said intervals are between 15 mm. and 30 mm.

89. Apparatus according to claim 82, wherein entrance mouths of those sparge holes in a middle portion of each row are of greater diameter than those of those sparge holes in an end portion of each row.

90. Apparatus according to claim 89, and further comprising first and second manifolds connected to the respective ends of said ducts for supplying said gaseous fluid to said ducts in respective opposite longitudinal directions of said ducts.

91. Apparatus according to claim 90, wherein a module comprised of said ducts and said manifolds fixed relative to each other is displaceable as a unit.

92. Apparatus according to claim 90, wherein those of said holes at middle portions of the respective ducts have larger entrance mouth diameters than those of said holes at portions of the respective ducts nearer to the ends of the ducts.

93. Apparatus according to claim 82, wherein each membrane is an ultrafiltration membrane and comprises an outer layer of polyether sulphone upon a fibrous thermoplastics substrate.

94. An apparatus according to claim 82, and further comprising, between the membranes of each pair of membranes, a plate having respective opposite major surfaces substantially parallel to each other, the membranes of each pair of membranes extending over and being spaced outwardly from the respective major surfaces of the relevant plate, and first and second sets of substantially vertical, liquid-flow, linear grooves formed in the respective major surfaces of each plate, the grooves in each set being parallel to each other, each two adjacent grooves in each set being spaced apart from each other by between 10 mm. and 50 mm., and each groove being of a width of between 0.5 mm. and 2 mm.

95. Apparatus according to claim 94, wherein each two adjacent grooves in each set are spaced apart from each other by between 20 mm. and 30 mm.

96. Apparatus according to claim 95, wherein each groove is of a width of between 1 mm. and 1.5 mm.

97. Apparatus according to claim 94, and further comprising first and second sets of liquid-collection grooves formed in the respective major surfaces of each plate and extending transversely of and intersecting the respective first and second sets of liquid-flow linear grooves, each of the liquid-collection grooves being of a depth of between 2 mm. and 5 mm.

98. Apparatus according to claim 94, and further comprising first and second sets of liquid-collection grooves formed in the respective major surfaces of each plate and extending transversely of and intersecting the respective first and second sets of liquid-flow linear grooves, each two adjacent liquid-collection grooves in each set being spaced apart from each other by between 2 mm. and 3 mm.

99. Apparatus according to claim 82, wherein the sparge holes are directed obliquely downwardly.

100. Apparatus according to claim 82, wherein each sparge hole is of a substantially frusto-conical form widening outwardly.

101. Apparatus according to claim 82, wherein each sparge hole has an entrance mouth diameter of 1.5 mm. and 2.5 mm.

102. Apparatus according to claim 82 and included in an activated sludge system.

103. Apparatus for use in separating liquid from a mixture of solid particles and liquid, and comprising:
a pair of substantially planar membranes which are substantially parallel to each other and are permeable to said liquid but substantially impermeable to said solid particles, each membrane being an ultrafiltration membrane with pore size of between 0.01 microns and 0.05 microns.

104. Apparatus according to claim 103, wherein said pore size is between 0.03 microns and 0.05 microns.

105. Apparatus according to claim 103, wherein each membrane comprises an outer layer of polyether sulphone upon a fibrous thermoplastics substrate.

106. Apparatus for use in separating liquid from a mixture of solid particles and liquid, and comprising:
(i) a plate having respective opposite major surfaces substantially parallel to each other,
(ii) first and second membranes extending over and spaced outwardly from the respective major surfaces of said plate and permeable to said liquid but substantially impermeable to said solid particles, and
(iii) first and second sets of liquid-flow linear grooves formed in said respective major surfaces, the grooves in each set being parallel to each other, each two adjacent grooves in each set being spaced apart from each other by between 10 mm. and 50 mm., and each groove being of a width of between 0.5 mm. and 2 mm.

107. Apparatus according to claim 106, wherein each two adjacent grooves in each set are spaced apart from each other by between 20 mm. and 30 mm.

108. Apparatus according to claim 106, wherein each groove is of a width of between 1 mm. and 1.5 mm.

109. Apparatus for use in separating liquid from a mixture of solid particles and liquid, and comprising:
(i) a plate having respective opposite major surfaces substantially parallel to each other,
(ii) first and second membranes extending over and spaced outwardly from the respective major surfaces of said plate and permeable to said liquid but substantially impermeable to said solid particles.
(iii) first and second sets of liquid-flow linear grooves formed in said respective major surfaces, the grooves in each set being parallel to each other, and
(iv) first and second sets of liquid-collection grooves formed in said respective major surfaces and extending transversely of and intersecting the respective first and second sets of liquid-flow linear grooves, each of the liquid-collection grooves being of a depth of between 2 mm. and 5 mm.

110. Apparatus for use in separating liquid from a mixture of solid particles and liquid, and comprising:
(i) a plate having respective opposite major surfaces substantially parallel to each other,
(ii) first and second membranes extending over and spaced outwardly from the respective major surfaces of said plate and permeable to said liquid but substantially impermeable to said solid particles,
(iii) first and second sets of liquid-flow linear grooves formed in said respective major surfaces, the grooves in each set being parallel to each other, and
(iv) first and second sets of liquid-collection grooves formed in said respective major surfaces and extending transversely of and intersecting the respective first and second sets of liquid-flow linear grooves, each two adjacent liquid-collection grooves in each set being spaced apart from each other by between 2 mm. and 3 mm.

111. A method of separating liquid from a mixture of solid particles, and liquid comprising introducing gaseous fluid into said mixture so as to form a plurality of substantially vertical curtains of gaseous bubbles, with the curtains being substantially parallel to each other, carrying the mixture upwards among a plurality of membranes which are substantially parallel to said curtains and which are permeable to said liquid and substantially impermeable to said solid particles, some of the liquid from said mixture flowing through said membranes, and collecting that liquid which has flowed through said membranes and thus been separated from said solid particles, said introducing comprising directing said gaseous fluid downwardly into said mixture within an included angle, centered on a vertical plane, of no more than one quarter of a right-angle, said mixture being activated sludge and said gaseous fluid comprising oxygen.

112. Apparatus comprising:
(i) an array of pairs of substantially vertical membranes substantially parallel to each other, each membrane having substantially vertical inner and outer major surfaces at respective opposite sides of the membrane, the membranes being spaced apart from each other and being permeable to liquid but substantially impermeable to solid particles,
(ii) a liquid flow channel arrangement between the membranes of each pair,
(iii) a liquid-collecting arrangement communicating with the liquid-flow channel arrangements for receiving liquid which has permeated through said membranes, and
(iv) gaseous fluid sparging ducts substantially parallel to the membranes and extending substantially horizontally for introducing gaseous fluid into a mixture of said liquid and said solid particles about said array, so that said gaseous fluid rises through the gaps among the outer major surfaces of the membranes, each gaseous fluid sparging duct being formed with sparge holes distributed therealong, the entrance mouths of those holes in a middle portion of each duct being of greater width than those of those holes in an end portion of the duct.

113. Apparatus according to claim 112, wherein said sparge holes are directed obliquely downwardly.

114. Apparatus according to claim 112, wherein each sparge hole is of a substantially frusto-conical form widening outwardly.

115. Apparatus according to claim 114, wherein each sparge hole has an entrance mouth diameter of 1.5 mm to 2.5 mm.

116. Apparatus according to claim 112, and further comprising first and second manifolds connected to the respective ends of said ducts for supplying said gaseous fluid to said ducts in respective opposite longitudinal directions of said ducts.

117. Apparatus comprising:
(i) an array of pairs of substantially vertical membranes substantially parallel to each other, each membrane having substantially vertical inner and outer major surfaces at respective opposite sides of the membrane, the membranes being spaced apart from each other and being permeable to liquid but substantially impermeable to solid particles,
(ii) a liquid flow channel arrangement between the membranes of each pair,
(iii) a liquid-collecting arrangement communicating with the liquid-flow channel arrangements for receiving liquid which has permeated through said membranes, and
(iv) gaseous fluid sparging ducts substantially parallel to the membranes and extending substantially horizontally for introducing gaseous fluid into a mixture of said liquid and said solid particles about said array, so that said gaseous fluid rises through the gaps among the outer major surfaces of the membranes, each gaseous fluid sparging duct being formed with sparge holes distributed therealong at intervals of no more than 30 mm.

118. Apparatus according to claim 117, wherein said intervals are between 10 mm. and 30 mm.

119. Apparatus according to claim 118, wherein said intervals are between 15 mm. and 30 mm.

120. Apparatus according to claim 117 and included in an activated sludge system.

121. A module comprising:
(i) an array of gaseous fluid sparging ducts substantially parallel to each other for introducing gaseous fluid into a mixture of liquid and solid particles, and
(ii) a manifold at an end of said array for supplying said gaseous fluid to said ducts, said ducts and said manifold being fixed relative to each other and said module being displaceable as a unit.

122. A module according to claim 121 and further comprising a second manifold at an opposite end of said array for supplying said gaseous fluid to said ducts, said ducts and said second manifold being fixed relative to each other.
